(19) United States
(12) Patent Application Publication
(10) Pub. No.: US 2021/0179812 A1
(43) Pub. Date: Jun. 17, 2021

(54) RUBBER COMPOSITION FOR INNER LINER AND PNEUMATIC TIRE USING THE SAME

(71) Applicant: Toyo Tire Corporation, Itami-shi (JP)

(72) Inventor: Masaki Kanaya, Itami-shi (JP)

(73) Assignee: Toyo Tire Corporation, Itami-shi (JP)

(21) Appl. No.: 17/117,608

(22) Filed: Dec. 10, 2020

(30) Foreign Application Priority Data
Dec. 13, 2019 (JP) 2019-225587

(51) Int. Cl. C08K 5/41; C08L 15/02; B60C 1/00

(52) U.S. Cl. CPC C08K 5/41; B60C 1/0008; C08L 15/02

(57) ABSTRACT

Provided are a rubber composition for an inner liner having excellent air permeability resistance and low temperature fatigue resistance, and a pneumatic tire using the same. The rubber composition for an inner liner contains 0.05 to 2.0 parts by mass of a thiosulfuric acid compound represented by the general formula (1) or (2) (m indicates an integer of 2 to 5, n indicates an integer of 1 to 3, and Mⁿ⁺ indicates a monovalent to trivalent metal ion) with respect to 100 parts by mass of rubber component, in which a whole sulfur content is 0.8 parts by mass or less.

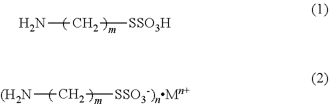

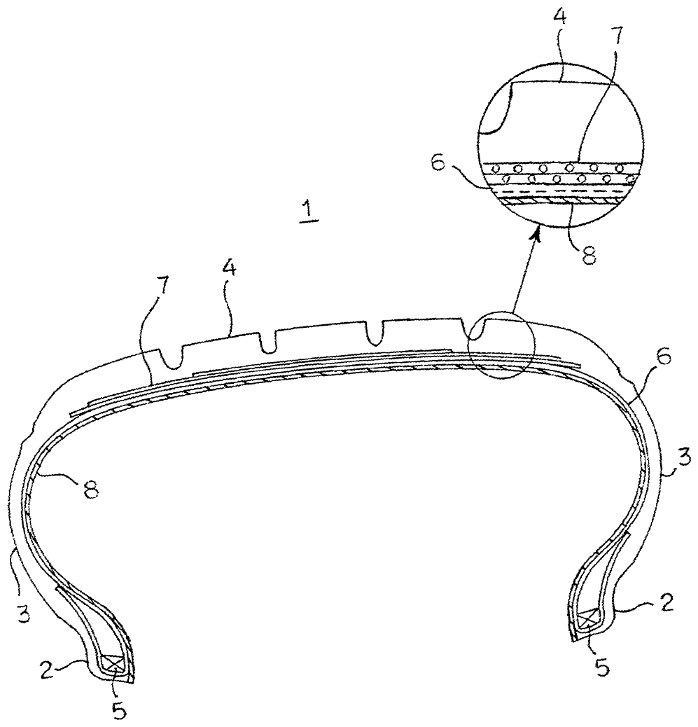

### BACKGROUND OF THE INVENTION

### 1. Field of the Invention

The present disclosure relates to a rubber composition for an inner liner and a pneumatic tire using the same.

### 2. Description of Related Art

An inner liner is provided on an inner surface of a pneumatic tire as an air permeation preventing layer in order to keep the tire air pressure constant. The inner liner is generally formed of a layer of rubber such as butyl rubber or butyl halogenated rubber with low air permeability.

Since the inner liner undergoes repeated bending deformation due to the rolling of the pneumatic tire, it is desired that the rubber composition used for the inner liner is excellent in strength (fatigue resistance) against repeated bending deformation, and is particularly desired to have excellent low temperature fatigue resistance in low temperature environments.

For example, JP-A-2016-138271 discloses, as a rubber composition having excellent air permeability resistance and crack growth resistance, a rubber composition for an inner liner of a tire which contains 50 parts by weight or more of butyl rubber, and contains 25 to 75 parts by mass of carbon black having a nitrogen adsorption specific surface area (N₂SA) of 25 to 95 m²/g, and 0.1 to 10 parts by mass of sodium anthraquinone sulfonate, for example, with respect to 100 parts by mass of the rubber component containing 5 parts by weight or more of a diene rubber. However, there is no mention about the low temperature fatigue resistance, and there also is room for improvement in low temperature fatigue resistance.

### SUMMARY OF THE INVENTION

In view of the above points, an object of the present disclosure is to provide a rubber composition for an inner liner having excellent air permeability resistance and low temperature fatigue resistance, and a pneumatic tire using the same.

While JP-A-2013-159678 discloses a rubber composition containing a thiosulfuric acid compound, the aim is to improve the viscoelastic properties of vulcanized rubber, and there is no description that gives suggestions on air permeability resistance or low temperature fatigue resistance.

A rubber composition for an inner liner according to the present disclosure contains 0.05 to 2.0 parts by mass of a thiosulfuric acid compound represented by general formula (1) or (2) with respect to 100 parts by mass of a rubber component, in which a whole sulfur content is 0.8 parts by mass or less.

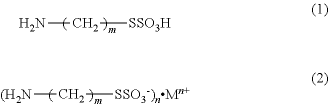

In formulas (1) and (2), m represents an integer of 2 to 5, and in formula (2), n represents an integer of 1 to 3, and Mⁿ⁺ represents a monovalent to trivalent metal ion.

In the rubber composition for an inner liner according to the present disclosure, the content ratios in 100 parts by mass of the rubber component can be 30 to 100% by mass of butyl rubber and 0 to 70% by mass of diene rubber.

A pneumatic tire of the present disclosure is manufactured by using the rubber composition for an inner liner described above.

According to the rubber composition for an inner liner of the present disclosure, a pneumatic tire having excellent air permeability resistance and low temperature fatigue resistance can be obtained.

### BRIEF DESCRIPTION OF DRAWINGS

The FIGURE is a cross-sectional view showing a pneumatic tire according to an embodiment of the present disclosure.

### DESCRIPTION OF EMBODIMENTS

Hereinafter, matters related to the embodiments of the present disclosure will be described in detail.

A rubber composition for an inner liner according to the present embodiment contains 0.05 to 2.0 parts by mass of a thiosulfuric acid compound represented by general formula (1) or (2) with respect to 100 parts by mass of a rubber component, in which a whole sulfur content is 0.8 parts by mass or less.

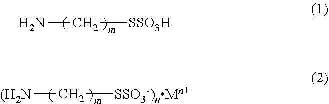

In formulas (1) and (2), m represents an integer of 2 to 5, and in formula (2), n represents an integer of 1 to 3, and Mⁿ⁺ represents a monovalent to trivalent metal ion. Examples of such a metal ion include sodium ion, potassium ion, calcium ion, aluminum ion and the like.

The rubber composition according to the present embodiment is not particularly limited, and examples thereof include butyl rubber and diene rubber, and preferably, the butyl rubber alone or a combination of the butyl rubber and the diene rubber.

Examples of the butyl rubber according to the present embodiment include a butyl halogenated rubber (e.g., a brominated butyl rubber (BIIR), a chlorinated butyl rubber (CIIR), and the like), and a butyl rubber (IIR).

Examples of the diene rubber according to the present embodiment include a natural rubber (NR), an isoprene rubber (IR), a butadiene rubber (BR), a styrene-butadiene rubber (SBR), a nitrile rubber (NBR), a chloroprene rubber (CR), and a styrene-isoprene rubber, a butadiene-isoprene rubber, a styrene-butadiene-isoprene rubber, and the like.

The rubber component according to the present embodiment preferably contains butyl rubber and diene rubber at a ratio of 30 to 100% by mass of butyl rubber and 0 to 70% by mass of diene rubber, more preferably, at a ratio of 50 to 100% by mass of butyl rubber and 0 to 50% by mass of diene rubber, and still more preferably, at a ratio of 80 to 100% by mass of butyl rubber and 0 to 20% by mass of diene rubber.

The content of the thiosulfuric acid compound according to the present embodiment is not particularly limited as long as it is 0.05 to 2.0 parts by mass, but is preferably 0.1 to 1.0 parts by mass, and more preferably 0.2 to 0.7 parts by mass with respect to 100 parts by mass of the rubber component.

By containing the thiosulfuric acid compound described above, the rubber composition according to the present embodiment can have improved low temperature fatigue resistance while maintaining air permeability resistance. Although the precise mechanism is not clear, it can be inferred as follows. That is, the thiosulfuric acid compounds of formulas (1) and (2) form a chemical bond with a filler such as carbon black or a polymer, so that gas diffusion is inhibited and air permeability resistance is improved. Since the thiosulfuric acid compounds represented by formulas (1) and (2) have a linear alkyl chain between the amino group and the sulfo group, the thiosulfuric acid compounds are more flexible than a compound used in JP-A-2016-138271 whose portion between substituents is rigid, and so it can be inferred that the flexibility of the entire rubber composition can be maintained, whereby the low temperature fatigue resistance is improved.

The whole sulfur content of the rubber composition according to the present embodiment is 0.8 parts by mass or less, preferably 0.4 parts by mass or less, and more preferably 0.2 parts by mass or less with respect to 100 parts by mass of the rubber component. When the whole sulfur content is within the ranges described above, excellent low temperature fatigue resistance can be easily obtained. The whole sulfur content of the present disclosure does not include a sulfur other than the sulfur discharged in the rubber and involved in cross-linking. For example, sulfur contained in di-2-benzothiazolyl disulfide (“NOCCELER DM-P” manufactured by Ouchi Shinko Chemical Industrial Co., Ltd.) or the like that can be compounded as a vulcanization accelerator is not included.

The rubber composition according to the present embodiment can include a pulverized bituminous coal obtained by finely crushing bituminous coal. The pulverized bituminous coal can improve air permeability resistance. The average particle size of the pulverized bituminous coal is preferably 0.5 to 100 and more preferably 1 to 30 μm. The average particle size can be measured by the laser diffraction/scattering method.

The pulverized bituminous coal having an aspect ratio of 5 to 30 can be used, for example. The aspect ratio is a ratio to the thickness of a long diameter (maximum dimension in the flat surface portion). The aspect ratio can be determined with the transmission electron microscope (TEM). Specifically, in a TEM image, the long diameter and the thickness of 10 randomly selected particles are measured to calculate the aspect ratio of each particle. The “aspect ratio of the pulverized bituminous coal” is the arithmetic mean of the aspect ratios.

The amount of the pulverized bituminous coal is preferably 5 to 50 parts by mass or more, more preferably 5 to 40 parts by mass, and still more preferably 5 to 30 parts by mass with respect to 100 parts by mass of the rubber component.

The rubber composition according to the present embodiment may contain carbon black as a filler. The iodine adsorption (IA) amount by carbon black can be 15 mg/g to 55 mg/g, for example. The iodine adsorption amount is a value measured in accordance with JIS K6217-1. The absorption amount of dibutyl phthalate (DBP) oil by carbon black can be, for example, 75 cm³/100 g to 125 cm³/100 g. The DBP oil absorption amount is a value measured in accordance with JIS K6217-4. Specifically, GPF grade carbon black is preferable.

The content of carbon black is preferably 30 to 70 parts by mass, and more preferably 40 to 60 parts by mass with respect to 100 parts by mass of component in the rubber composition.

The total amount of carbon black and the pulverized bituminous coal is preferably 35 to 120 parts by mass, more preferably 40 to 110 parts by mass, and still more preferably 50 to 100 parts by mass with respect to 100 parts by mass of the rubber component in the rubber composition.

Zinc oxide may be added to the rubber composition according to the present embodiment. The zinc oxide is added as a vulcanizing agent (crosslinking agent) for butyl halogenated rubber, and added in an amount of preferably 0.5 to 10 parts by mass, and more preferably 1 to 5 parts by mass with respect to 100 parts by mass of the rubber component.

A tackifying agent may be added to the rubber composition according to the present embodiment. The tackifying agent is an additive that imparts stickiness to unvulcanized rubber composition, and is also referred to as a tackifier. The tackifying agent is preferably hydrocarbon resin such as aliphatic petroleum resin, aromatic petroleum resin, and aliphatic/aromatic copolymer petroleum resin, and more preferably, CS-based petroleum resin obtained by cationically polymerizing an unsaturated monomer such as isoprene or cyclopentadiene which is a petroleum fraction equivalent to 4 to 5 carbon atoms. The amount of the tackifying agent is not particularly limited, but is preferably 1 to 15 parts by mass, and more preferably 2 to 10 parts by mass with respect to 100 parts by mass of the rubber component.

The method for producing the rubber composition according to the present embodiment is not particularly limited, and can be produced by kneading with a commonly used mixing machine, such as a Banbury mixer, a kneader, or a roll, according to a method of the related arts. For example, a rubber composition can be prepared by adding other additives excluding a vulcanizing agent and a vulcanization accelerator to the diene rubber followed by kneading in a first mixing stage (non-processing kneading process), and then adding a vulcanizing agent and a vulcanization accelerator to the resultant mixture followed by kneading in a final mixing step (processing kneading process).

In addition to the components described above, various additives usually added in the rubber composition for an inner liner, such as an age resister, an oil, a processing aid, sulfur, and a vulcanization accelerator, can be added in the rubber composition according to the present embodiment. Examples of sulfur include powdered sulfur, precipitated sulfur, colloidal sulfur, insoluble sulfur, and highly dispersible sulfur, and is preferably added in an amount of 0.78 parts by mass or less (may not be added), and more preferably 0.2 parts by mass or less with respect to 100 parts by mass of the rubber component. The amount of the oil is preferably 5 parts by mass or less with respect to 100 parts by mass of the rubber component, and is preferably not substantially contained (specifically, less than 1 part by mass) from the viewpoint of gas permeability resistance.

The rubber composition for an inner liner according to the present embodiment can be applied to various pneumatic tires such as tires for various automobiles including tires for passenger cars, heavy-duty tires for trucks, buses and the like, and tires for two-wheeled vehicles including bicycles.

The FIGURE is a cross-sectional view showing a pneumatic tire 1 according to an embodiment. As shown, the pneumatic tire 1 includes a pair of bead portions 2 to be rim-assembled, a pair of sidewall portions 3 extending outward in the radial direction of the tire from the bead portions 2, and a tread portion 4 provided between the pair of sidewall portions 3 and grounded on the road surface. A ring-shaped bead core 5 is embedded in each of the pair of bead portions 2. A carcass ply 6 using an organic fiber cord is folded around the bead core 5 and locked, and is provided to be bridged between the left and right bead portions 2. On an outer peripheral side of the tread portion 4 of the carcass ply 6, a belt 7 formed of two belt plies using a rigid tire cord such as a steel cord or an aramid fiber is provided.

Inside the carcass ply 6, an inner liner 8 is provided over the entire inner surface of the tire. In the present embodiment, the rubber composition for an inner liner is used as the inner liner 8. The inner liner 8 is attached to the inner surface of the carcass ply 6, which is the rubber layer on the inner surface side of the tire, as shown in the enlarged view in the FIGURE, and more specifically, is attached to the inner surface of a topping rubber layer covering the cord of the carcass ply 6.

A method for manufacturing a pneumatic tire according to the present embodiment includes, for example, with the rubber composition for an inner liner as an inner liner, mounting the inner liner in a tubular shape on an outer circumference of a molding drum, attaching a carcass ply thereon, further assembling and inflating each tire member such as a belt, tread rubber and sidewall rubber to produce a green tire (unvulcanized tire), and vulcanizing and molding the green tire in a mold to produce a pneumatic tire. In the example shown in the FIGURE, although the rubber composition for an inner liner is provided on the inner surface side of the carcass ply, as long as the tire pressure can be maintained by preventing the permeation of air from the inside of the tire, that is, as long as the rubber composition for an inner liner is provided as an air permeation preventing layer for maintaining the internal pressure, the rubber composition for an inner liner can be provided at various positions such as on the outer surface side of the carcass ply, and there is no particular limitation thereto.

### EXAMPLES

Hereinafter, certain examples of the present disclosure are described below, but the present disclosure is not construed as being limited to the examples.

By using a Banbury mixer, the components excluding the vulcanization accelerator were first added and mixed in the non-processing kneading step (discharge temperature=150° C.) according to the formulation (parts by mass) shown in Table 1 below, and in the processing kneading step, the vulcanization accelerator was added and mixed (discharge temperature=90° C.) to prepare a rubber composition for an inner liner. The details of each components in Table 1 are as follows.
Brominated butyl rubber: “Bromobutyl 2222” manufactured by JAPAN BUTYL Co., Ltd.
Carbon black: “SEAST V” manufactured by Tokai Carbon Co., Ltd.
Pulverized bituminous coal: “Austin Black 325” manufactured by Coal Fillers, Inc.
Tackifying agent: “T-REZ RA100” manufactured by Tonen Chemical Corp.
Oil: “PROCESS NC-140” manufactured by JXTG Nippon Oil & Energy

Corp.
Thiosulfuric acid compound 1: S-(3-aminopropyl)thiosulfuric acid, mass ratio of sulfur in one molecule=37.4% by mass
Thiosulfuric acid compound 2: S-(3-aminopropyl)sodium thiosulphate, mass ratio of sulfur in one molecule=33.2 mass %
Thiosulfuric acid compound 3: S-(2-aminoethyl)thiosulfuric acid, mass ratio of sulfur in one molecule=40.7 mass %
Sodium 2-anthraquinone sulfonate, mass ratio of sulfur in one molecule=10.3% by mass
Zinc oxide: “Zinc Oxide 3 Species” manufactured by Mitsui Mining & Smelting Co., Ltd.
Stearic acid: “LUNAC S-20” manufactured by Kao Corporation
Vulcanization accelerator: “NOCCELER-DM-P” manufactured by Ouchi Shinko Chemical Industrial Co., Ltd.

The resultant rubber composition was evaluated for air permeability resistance and low temperature fatigue resistance. Each evaluation method is as follows.
Air permeability resistance: For a vulcanized rubber sheet with a thickness of 1 mm that was vulcanized at 160° C. for 30 minutes, the air permeability was measured using a gas permeability tester (“BT-3” manufactured by Toyo Seiki Seisaku-sho, Ltd.), and an index was represented relative to the value of Comparative Example 1 as 100. It is demonstrated that as the numerical value is larger, the air permeability resistance is better.
Low temperature fatigue resistance: In accordance with JIS K6260, the number of times of flexing of a test sample vulcanized at 160° C. for 30 minutes was measured at −35° C. until the crack length reached 10 mm with a De Mattia flex test device. An index was represented relative to the number of flexing in Comparative Example 1 as 100, and it is demonstrated that, as the numerical value is smaller, the low temperature flexural fatigue resistance is better. The length of the naturally occurring crack was added to the crack length.

TABLE 1

| | Com. 1 | Com. 2 | Com. 3 | Com. 4 | Ex. 1 | Ex. 2 | Ex. 3 | Ex. 4 | Ex. 5 |
|---|---|---|---|---|---|---|---|---|---|
| Brominated butyl | 100 | 100 | 100 | 100 | 100 | 100 | 100 | 100 | 100 |
| rubber | | | | | | | | | |
| Carbon black | 50 | 50 | 50 | 50 | 50 | 50 | 50 | 50 | 50 |
| Pulverized bituminous | 10 | 10 | 10 | 10 | 10 | 10 | 10 | 10 | 10 |
| coal | | | | | | | | | |
| Tackifiying agent | 3 | 3 | 3 | 3 | 3 | 3 | 3 | 3 | 3 |
| Oil | 5 | 10 | 5 | 5 | 5 | 5 | 5 | 5 | 5 |
| Thiosulfuric acid | — | — | 5 | — | 0.1 | 0.5 | 2 | — | — |
| compound 1 | | | | | | | | | |
| Thiosulfuric acid | — | — | — | — | — | — | — | 0.5 | — |
| compound 2 | | | | | | | | | |
| Thiosulfuric acid | — | — | — | — | — | — | — | — | 0.5 |
| compound 3 | | | | | | | | | |
| Sodium | — | — | — | 0.5 | — | — | — | — | — |
| 2-anthraquinone | | | | | | | | | |
| sulfonate | | | | | | | | | |
| Zinc oxide | 3 | 3 | 3 | 3 | 3 | 3 | 3 | 3 | 3 |
| Stearic acid | 1 | 1 | 1 | 1 | 1 | 1 | 1 | 1 | 1 |
| Vulcanization | 2 | 2 | 2 | 2 | 2 | 2 | 2 | 2 | 2 |
| accelerator | | | | | | | | | |
| Whole sulfur content | 0 | 0 | 1.65 | 0.052 | 0.037 | 0.187 | 0.748 | 0.166 | 0.204 |
| Air permeability | 100 | 75 | 89 | 100 | 112 | 110 | 100 | 112 | 108 |
| resistance | | | | | | | | | |
| Low temperature | 100 | 90 | 60 | 90 | 55 | 40 | 30 | 40 | 35 |
| fatigue resistance | | | | | | | | | |

The results are as shown in Table 1, and from the comparison between Comparative Example 1 and Examples 1 to 5, it can be seen that when the content of the thiosulfuric acid compound and the whole sulfur content are within the predetermined ranges, the air permeability resistance is maintained or improved, and the low temperature fatigue resistance is improved.

From the comparison between Comparative Examples 1 and 2, it can be seen that the air permeability resistance was deteriorated when the amount of oil was increased.

From the comparison between Comparative Examples 1 and 3, it can be seen that when the content of the thiosulfuric acid compound exceeds a predetermined range, the air permeability resistance is deteriorated.

From the comparison between Comparative Examples 1 and 4, it can be seen that when sodium 2-anthraquinone sulfonate described in JP-A-2016-138271 was used instead of the thiosulfuric acid compound, the low temperature fatigue resistance was improved while maintaining the air permeability resistance, but the effect of improving the low temperature fatigue resistance was inferior to that of Examples 1 to 5.

The rubber composition for an inner liner according to the present disclosure can be used for the inner liners of various tires of passenger cars, light duty trucks, buses and the like.

What is claimed is:

1. A rubber composition for an inner liner containing 0.05 to 2.0 parts by mass of a thiosulfuric acid compound represented by the general formula (1) or (2) with respect to 100 parts by mass of a rubber component, wherein a whole sulfur content is 0.8 parts by mass or less: 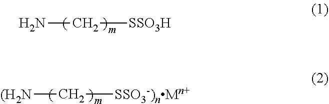
in formulas (1) and (2), m represents an integer of 2 to 5, and in formula (2), n represents an integer of 1 to 3, and Mⁿ⁺ represents a monovalent to trivalent metal ion.

2. The rubber composition for an inner liner according to claim 1, wherein in 100 parts by mass of the rubber component, a content ratio is 30 to 100% by mass for butyl rubber and 0 to 70% by mass for diene rubber.

3. A pneumatic tire manufactured by using the rubber composition for an inner liner according to claim 1.

4. A pneumatic tire manufactured by using the rubber composition for an inner liner according to claim 2.
